(19) United States
(12) Patent Application Publication
(10) Pub. No.: US 2004/0123428 A1
(43) Pub. Date: Jul. 1, 2004

(54) Reinforcing member for a knob for a lock

(75) Inventor: Su-Mei Hsu, Kaohsiung Hsien (TW)

Correspondence Address: BACON & THOMAS, PLLC, 625 SLATERS LANE, FOURTH FLOOR, ALEXANDRIA, VA, 22314

(73) Assignee: Taiwan Fu Hsing Industrial Co., Ltd., Kaohsiung Hsien (TW)

(21) Appl. No.: 10/329,432

(22) Filed: Dec. 27, 2002

(51) Int. Cl. E05B 3/00

(52) U.S. Cl. 16/414

(57) ABSTRACT

A knob for a lock includes a knob body and a reinforcing member. The knob body has a side, and a neck extends outward from the side of the knob body and has a slot. The reinforcing member is mounted around the neck and has a stop that is engaged in the slot of the neck. An escutcheon is mounted around the reinforcing member. The knob has increased strength for withstanding larger force intended to destroy the lock through either jimmying the connection area between the side of the knob body and an end wall of the escutcheon or hammering an outer face of the knob body.

### BACKGROUND OF THE INVENTION

1. Field of the Invention

The present invention relates to a reinforcing member for a knob of a lock to improve the strength of the knob for preventing destruction of the knob by an unauthorized user.

2. Description of the Related Art

FIG. 1 of the drawings illustrates a conventional knob and FIG. 2 illustrates a lock having the conventional knob in FIG. 1. The knob includes a knob body 90 and a neck 91 extending from a side of the knob body 90. An escutcheon 92 is mounted around the neck 91. When mounted to a door, an unauthorized user may use a sharp-pointed member 93 to jimmy the connection area between the knob body 90 and the escutcheon 92. Alternatively, the unauthorized user may directly hammer an outer surface of the knob body 90, which, in turn, presses against the escutcheon 92 and thus causes deformation of the escutcheon 92. As a result, the lock core can be removed.

### SUMMARY OF THE INVENTION

An object of the present invention is to provide a reinforcing member for a knob of a lock to improve the strength of the knob for preventing destruction of the knob by an unauthorized user.

A knob for a lock in accordance with the present invention includes a knob body and a reinforcing member. The knob body has a side, and a neck extends outward from the side of the knob body and has a slot. The reinforcing member is mounted around the neck and has a stop that is engaged in the slot of the neck.

In an embodiment of the invention, the reinforcing member includes a cylindrical portion mounted around the neck. The cylindrical portion has a first end and a second end. The reinforcing member further includes a conic wall projecting from the first end of the cylindrical portion and extending to a position beyond the second end of the cylindrical portion. An abutting end wall projects from a distal end of the conic wall and extends on a plane orthogonal to a longitudinal direction of the cylindrical portion, with the abutting end wall abutting against the side of the knob body. An escutcheon is mounted around the conic wall of the reinforcing member.

In another embodiment of the invention, the reinforcing member is integrally formed by casting and includes a cylindrical portion, an abutting end wall, and a stop. The reinforcing member is covered by an escutcheon, with the cylindrical portion mounted around the neck, with the abutting end wall abutting against the side of the knob body, and with the stop being engaged in the lock core engaging slot of the neck and abutting against the end face of the slot of the spindle. The reinforcing member may further include a recessed portion for abutting against the end face of the protruded portion of the lock core.

The knob in accordance with the present invention has increased strength for withstanding larger force intended to destroy the lock through either jimmying the connection area between the side of the knob body and the end wall of the escutcheon or hammering an outer face of the knob body.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an exploded perspective view of a conventional knob.

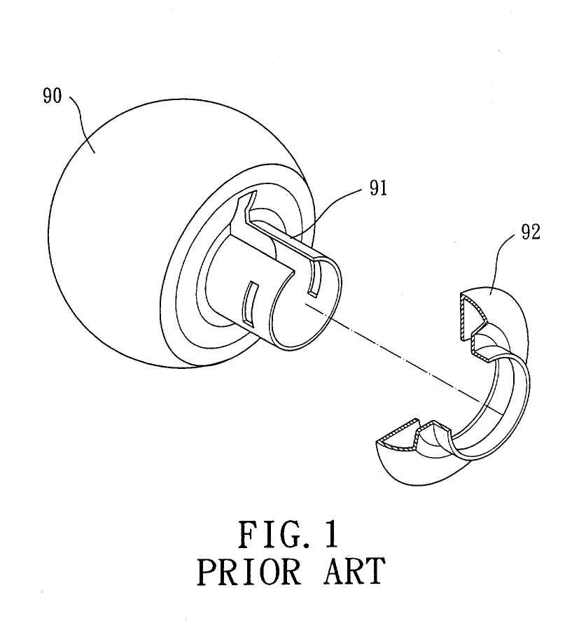

FIG. 2 is a sectional view of a lock with the conventional knob of FIG. 1.

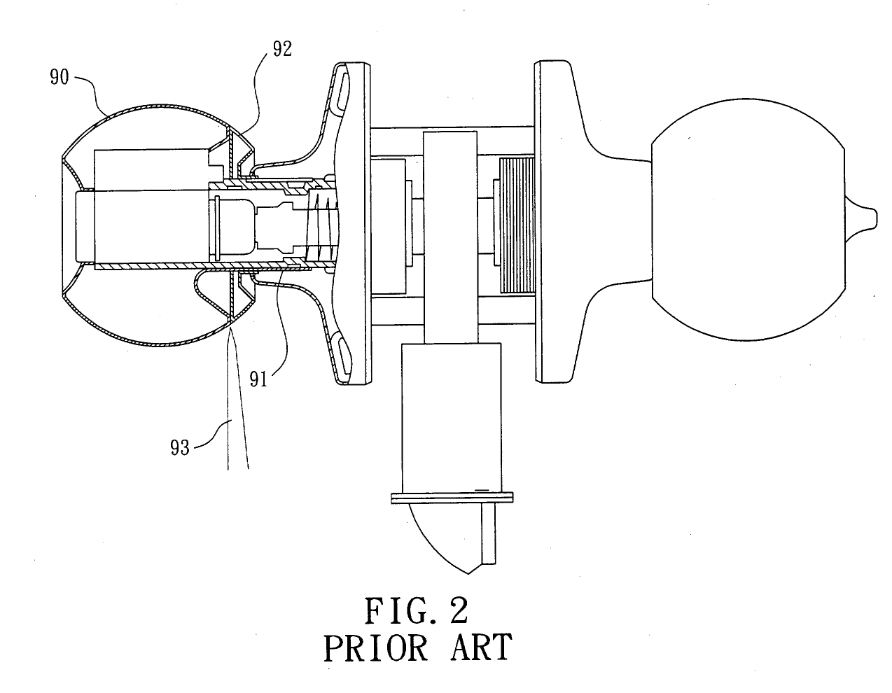

FIG. 3 is an exploded perspective view of a first embodiment of a knob in accordance with the present invention.

FIG. 4 is a sectional view of a lock with the knob in FIG. 3.

FIG. 5 is an exploded perspective view of a second embodiment of the knob in accordance with the present invention.

FIG. 6 is a sectional view of a lock with the knob in FIG. 5.

### DETAILED DESCRIPTION OF THE PREFERRED EMBODIMENTS

Preferred embodiments in accordance with the present invention will now be described with reference to the accompanying drawings.

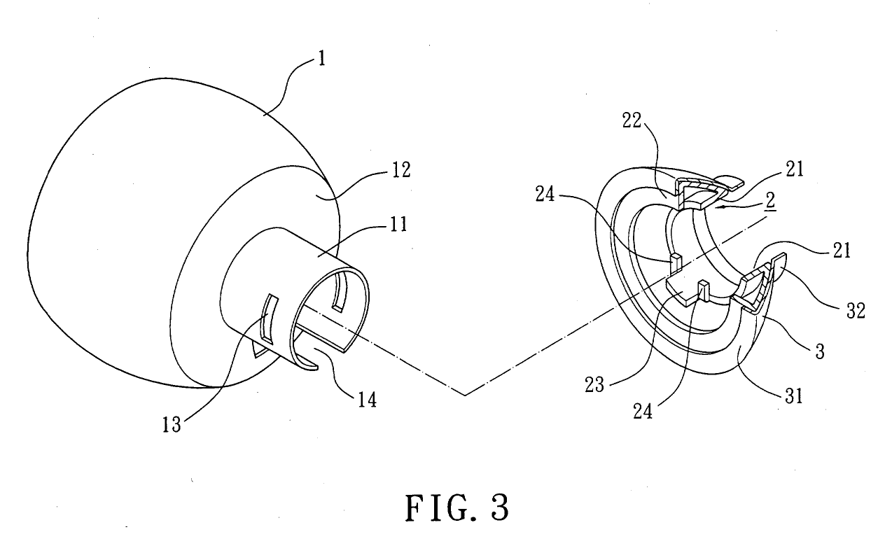

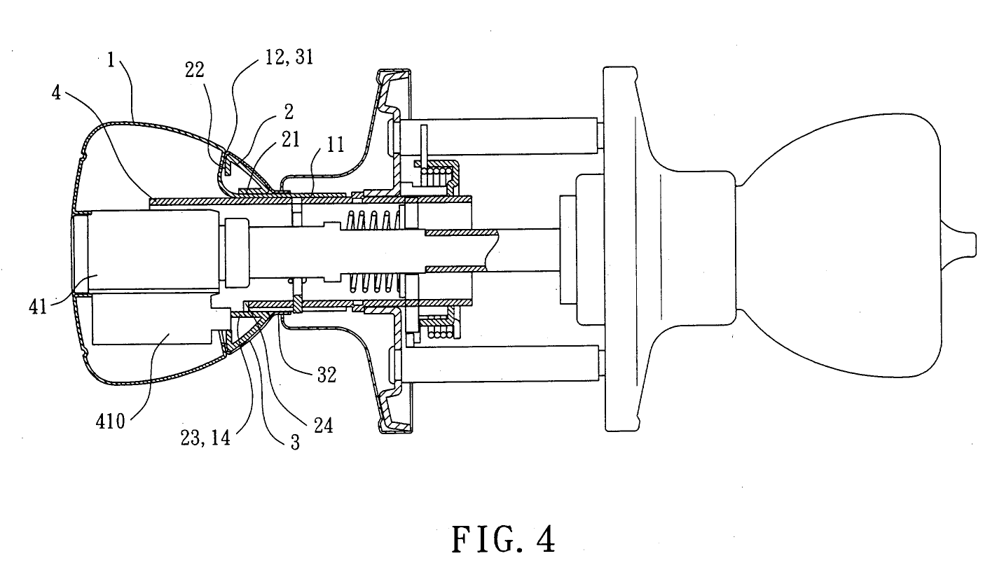

Referring to FIGS. 3 and 4, a first embodiment of a knob in accordance with the present invention generally includes a knob body 1, a reinforcing member 2, and an escutcheon 3.

The knob body 1 can be of any conventional shape and includes a neck 11 extending from a side 12 thereof for receiving a lock core 41 (FIG. 4). The reinforcing member 2 is mounted around the neck 11. The neck 11 includes an engaging slot 13 and a lock core engaging slot 14 for receiving a protruded portion 410 of a lock core 41 (FIG. 4), which are conventional.

The reinforcing member 2 is formed by means of punching a metal sheet having a certain thickness. The reinforcing member 2 includes a cylindrical portion 21 so as to be mounted around the neck 11. Further, the reinforcing member 2 has an abutting end wall 22 for abutting against the side 12 of the knob body 1. In this embodiment, a conic wall 25 projects from a first end of the cylindrical portion 21 and extends rearward to a position beyond a second end of the cylindrical portion 21, with an abutting end wall 22 extending from a distal end of the conic wall 25. Preferably, the abutting end wall 22 lies on a plane orthogonal to a longitudinal direction of the cylindrical portion 21. An engaging piece 23 projects from the second end of the cylindrical portion 21 and extends away from the first end of the cylindrical portion 21. Further, two stops 24 projects from the second end of the cylindrical portion 21 and extends radially inward. Preferably, the stops 24 are respectively provided on two sides of the engaging piece 23. The stops 24 are engaged in the lock core engaging slot 14 and abut against an end face (not labeled) of a slot 42 of a spindle 4 that is mounted to the neck 11 to turn therewith. The engaging piece 23 abuts against an end face (not labeled) of the protruded portion 410 of the lock core 41.

The escutcheon 3 is mounted around the reinforcing member 2 to provide an esthetically pleasing appearance. The escutcheon 3 is in intimate contact with an outer face of the conic wall 25 of the reinforcing member 2. An end wall 31 projects from an end of the escutcheon 3 and extends on a plane orthogonal to a longitudinal axis of the escutcheon 3. The end wall 31 abuts against the abutting end wall 22 of the reinforcing member 2. Further, an annular extension 32 projects from the other end of the escutcheon 3 and extends in a direction substantially parallel to the longitudinal axis of the escutcheon 3. The annular extension 32 extends beyond the first end of the cylindrical portion 21.

As illustrated in FIG. 4, the neck 11 is mounted around the spindle 4, the cylindrical portion 21 of the reinforcing member 2 is mounted around the neck 11, and the escutcheon 3 is mounted around the reinforcing member 2. The end wall 31 of the escutcheon 3 abuts against the side 12 of the knob body 1 (or the abutting end wall 22 of the reinforcing member 2 abuts against the side 12 of the knob body 1, if the escutcheon 3 is omitted). The stops 24 are engaged in the lock core engaging slot 14 of the neck 11 and abut against the end face of the slot 42 of the spindle 4.

In this embodiment, since the end wall 31 of the escutcheon 3 abuts against the side 12 of the knob body 1, since the stops 24 are engaged in the lock core engaging slot 14 of the neck 11 and abut against the end face of the slot 42 of the spindle 4, and since the engaging piece 23 of the reinforcing member 2 abuts against the protruded portion 410 of the lock core 41, the increased thickness provided by the reinforcing member 2 may withstand stronger force applied by an unauthorized user for jimmying the lock through the connection area between the end wall 31 of the escutcheon 3 and the side 12 of the knob body 1. Thus, the jimmying is vain. Further, if the unauthorized user hammers the knob body 1, since the stops 24 of the reinforcing member 2 are engaged in the lock core engaging slot 14 of the neck 11, since the stops 24 abut against the end face of the slot 42 of the spindle 4, and since the engaging piece 23 of the reinforcing member 2 abuts against the protruded portion 410 of the lock core 41, the external hammering impact could be transmitted through the lock core 41 or the knob body 1 to the reinforcing member 2 that abuts against the spindle 4. Thus, it is difficult to destroy the lock having a knob in accordance with the present invention.

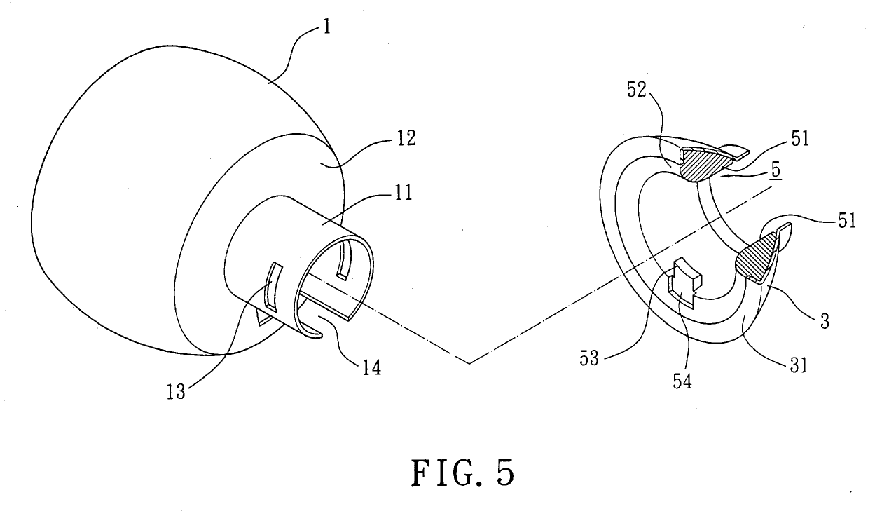

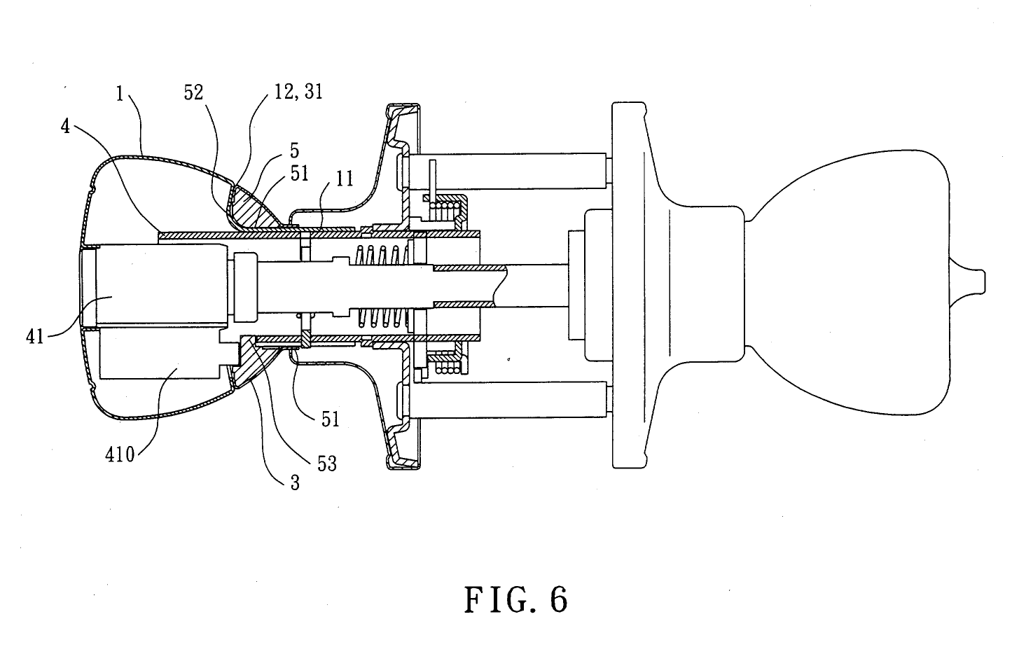

FIG. 5 shows a second embodiment of the knob in accordance with the present invention, and FIG. 6 shows a lock with the knob in FIG. 5. In this embodiment, the reinforcing member (now designated by 5) is integrally formed by casting and includes a cylindrical portion 51, an abutting end wall 52, and a stop 53. The reinforcing member 5 is covered by the escutcheon 3, with the cylindrical portion 51 mounted around the neck 11, with the abutting end wall 52 abutting against the side 12 of the knob body 1, and with the stop 53 being engaged in the lock core engaging slot 14 of the neck 1 and abutting against the end face of the slot 42 of the spindle 4. The reinforcing member 5 may further include a recessed portion 54 for abutting against the end face of the protruded portion 410 of the lock core 41. Thus, the reinforcing member 5 may retain the lock core 41 in place while withstanding external impact transmitted through the lock core 41.

In this embodiment, the reinforcing member 5 has increased strength and thus may withstand larger force intended to destroy the lock, as the reinforcing member 5 is integrally formed as a single unit.

The knob in accordance with the present invention has increased strength for withstanding larger force intended to destroy the lock through either jimmying the connection area between the side 12 of the knob body 1 and the end wall 31 of the escutcheon 3 or hammering the outer face of the knob body 1.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A knob for a lock comprising:
a knob body having a side, a neck extending outward from the side of the knob body and having a slot; and
a reinforcing member mounted around the neck, the reinforcing member having a stop that is engaged in the slot of the neck.

2. The knob as claimed in claim 1, wherein the reinforcing member includes a cylindrical portion having an abutting end wall that abuts against the side of the knob body.

3. The knob as claimed in claim 2, wherein the abutting end wall extends on a plane orthogonal to a longitudinal direction of the cylindrical portion.

4. The knob as claimed in claim 1, wherein the stop of the reinforcing member abuts against an end face of a slot of a spindle that is mounted to the neck to turn therewith.

5. The knob as claimed in claim 1, wherein the reinforcing member is formed by means of punching a metal sheet of a thickness.

6. The knob as claimed in claim 1, wherein the reinforcing member is integrally formed from metal as a single unit.

7. The knob as claimed in claim 1, wherein the reinforcing member includes an engaging piece for abutting against a protruded portion of a lock core.

8. The knob as claimed in claim 1, wherein the reinforcing member includes a recessed portion for abutting against a protruded portion of a lock core.

9. The knob as claimed in claim 1, wherein the reinforcing member includes a cylindrical portion mounted around the neck, the cylindrical portion having a first end and a second end, the reinforcing member further including a conic wall projecting from the first end of the cylindrical portion and extending to a position beyond the second end of the cylindrical portion, an abutting end wall projecting from a distal end of the conic wall and extending on a plane orthogonal to a longitudinal direction of the cylindrical portion, with the abutting end wall abutting against the side of the knob body.

10. The knob as claimed in claim 1, further including an escutcheon mounted around the reinforcing member.

11. The knob as claimed in claim 10, wherein the reinforcing member includes a cylindrical portion mounted around the neck, the cylindrical portion having a first end and a second end, the reinforcing member further including a conic wall projecting from the first end of the cylindrical portion and extending to a position beyond the second end of the cylindrical portion, an abutting end wall projecting from a distal end of the conic wall and extending on a plane orthogonal to a longitudinal direction of the cylindrical portion, with the escutcheon being mounted around the conic wall of the reinforcing member.

12. The knob as claimed in claim 11, wherein the escutcheon includes an end wall that projects from an end of the escutcheon adjacent to the abutting end wall of the reinforcing member, with the end wall of the escutcheon abutting against the abutting end wall of the reinforcing member, and with the end wall of the escutcheon abutting against the side of the knob body.

13. The knob as claimed in claim 12, wherein the escutcheon includes an extension projecting from another end of the escutcheon and extending beyond the first end of the cylindrical portion of the reinforcing member.

14. The knob as claimed in claim 10, wherein the reinforcing member is integrally formed from metal as a single unit.

15. The knob as claimed in claim 14, wherein the reinforcing member has an abutting end wall.

16. The knob as claimed in claim 15, wherein the escutcheon includes an end wall that projects from an end of the escutcheon adjacent to the abutting end wall of the reinforcing member, with the end wall of the escutcheon abutting against the abutting end wall of the reinforcing member, and with the end wall of the escutcheon abutting against the side of the knob body.

17. The knob as claimed in claim 16, wherein the escutcheon includes an extension projecting from another end of the escutcheon and extending beyond the first end of the cylindrical portion of the reinforcing member.
